(19) United States
(12) Patent Application Publication
(10) Pub. No.: US 2026/0120556 A1
(43) Pub. Date: Apr. 30, 2026

(54) SYSTEM AND METHOD FOR ALARM ANALYSIS AND VERIFICATION

(71) Applicant: GENETEC INC., Saint-Laurent (CA)

(72) Inventor: Florian MATUSEK, Vienna (AT)

(21) Appl. No.: 18/933,159

(22) Filed: Oct. 31, 2024

(51) Int. Cl. G08B 29/18; G08B 13/196

(52) U.S. Cl. CPC G08B 29/18; G08B 13/196

(57) ABSTRACT

A method for alarm verification comprises obtaining an alarm indication associated with a potential alarm triggered at a monitored site, obtaining media data captured by at least one media device, executing a machine learning model to conduct a content analysis of the media data and generate content metadata based thereon, obtaining sensor data acquired by at least one sensor, correlating the content metadata with the sensor data to determine whether an event corresponding to an alarm condition has occurred at the monitored site, in response to detecting occurrence of the event, determining that the alarm indication relates to a security issue and causing a first action to be performed to mitigate the security issue, and, in response to detecting that the event failed to occur, determining that the alarm indication relates to an operational issue and causing a second action to be performed to mitigate the operational issue.

### FIELD

The improvements generally relate to surveillance systems, and more particularly to alarm analysis and verification in a surveillance system.

### BACKGROUND

Surveillance systems are typically composed of a variety of different devices, such as cameras, sensors, and other devices, that generate data as a site is being surveilled. These devices are relied upon to trigger an alarm when an anomalous event or condition is detected. However, false alarms are often triggered by causes other than anomalies, leading to wasted resources.

In existing surveillance systems, alarms are generally validated through time-consuming means, such as via telephone communication with personnel at a central monitoring station. In addition, validation of multiple alarms using existing surveillance systems can prove challenging and costly due to the difficulty in effectively triaging information associated with multiple video streams.

Therefore, while existing surveillance systems are suitable for their purposes, there remains room for improvement.

### SUMMARY

The following presents a simplified summary of one or more implementations in accordance with aspects of the present disclosure, in order to provide a basic understanding of such implementations, without limiting the embodiments presented within the present disclosure. While existing surveillance systems are suitable for their purposes, the management and verification of alarms using such systems can prove burdensome. To this end, the present disclosure provides methods and systems for alarm analysis and verification in a surveillance system. In response to an alarm being triggered at a monitored site, a content analysis of media data captured by at least one media device deployed at the site is conducted. The result of the content analysis is correlated with data acquired by at least one sensor deployed at the site in order to assess whether at least one event corresponding to an alarm condition has occurred. One or more actions are then taken based on the assessment.

In accordance with one aspect, there is provided a method for alarm verification in a surveillance system comprising one or more media devices and one or more sensors deployed at a monitored site. The method comprises, at a computing device in communication with a machine learning model, obtaining at least one alarm indication associated with at least one potential alarm triggered at the monitored site, obtaining media data captured by at least one of the one or more media devices, executing the machine learning model to conduct a content analysis of the media data and generate content metadata based on the content analysis, obtaining sensor data acquired by at least one of the one or more sensors, correlating the content metadata with the sensor data to determine whether at least one event corresponding to an alarm condition has occurred at the monitored site, in response to detecting occurrence of the at least one event corresponding to the alarm condition, determining that the at least one alarm indication relates to a security issue and causing at least one first action to be performed to mitigate the security issue, and, in response to detecting that the at least one event corresponding to the alarm condition failed to occur, determining that the at least one alarm indication relates to an operational issue and causing at least one second action to be performed to mitigate the operational issue.

In at least one embodiment in accordance with any previous/other embodiment described herein, the at least one alarm indication is obtained from the surveillance system in real-time.

In at least one embodiment in accordance with any previous/other embodiment described herein, the at least one alarm indication is obtained from the one or more media devices and/or the one or more sensors.

In at least one embodiment in accordance with any previous/other embodiment described herein, the at least one alarm indication is obtained from a third-party system coupled to the surveillance system.

In at least one embodiment in accordance with any previous/other embodiment described herein, the at least one alarm indication is generated, at the computing device, based on at least one of the media data and the sensor data.

In at least one embodiment in accordance with any previous/other embodiment described herein, the method further comprises identifying the at least one of the one or more media devices based on a distance between a location of the at least one media device and a location at which the at least one potential alarm was triggered.

In at least one embodiment in accordance with any previous/other embodiment described herein, a displacement of at least one object along a direction movement caused the at least one potential alarm to be triggered, the method further comprising identifying the at least one of the one or more media devices based on a position of the at least one media device relative to the direction of movement.

In at least one embodiment in accordance with any previous/other embodiment described herein, the method further comprises identifying the at least one of the one or more sensors based on topological data associated with the monitored site, the topological data indicative of a layout of areas of the monitored site and of an arrangement of the one or more sensors within the areas.

In at least one embodiment in accordance with any previous/other embodiment described herein, obtaining the media data comprises retrieving the media data from a plurality of event occurrence records stored in at least one database and/or obtaining the sensor data comprises retrieving the sensor data from the plurality of event occurrence records.

In at least one embodiment in accordance with any previous/other embodiment described herein, obtaining the media data comprises receiving the media data from the at least one of the one or more media devices and/or obtaining the sensor data comprises receiving the sensor data from the at least one of the one or more sensors.

In at least one embodiment in accordance with any previous/other embodiment described herein, obtaining the media data comprises obtaining at least one of image data and video data.

In at least one embodiment in accordance with any previous/other embodiment described herein, the content metadata is indicative of at least one of a detected presence of one or more individuals and/or objects at the monitored site, a number of the one or more individuals and/or objects, a detected motion of the one or more individuals and/or objects, and at least one of a speed of motion and a direction of motion of the one or more individuals and/or objects.

In at least one embodiment in accordance with any previous/other embodiment described herein, the sensor data is acquired by the at least one of the one or more sensors comprising at least one motion sensor, at least one glass breakage sensor, at least one door contact sensor, at least one window contact sensor, at least one request to exit sensor, at least one fire sensor, at least one smoke sensor, at least one sound sensor, at least one infrared sensor, at least one pressure sensor, at least one tension sensor, at least one magnetic sensor, at least one temperature sensor, at least one humidity sensor, and/or at least one access control device.

In at least one embodiment in accordance with any previous/other embodiment described herein, the at least one event comprises a door forced open event, a door held open event, an access denied event, a break event, a fire, a gunshot event, a person detected event, a vehicle detected event, an object detected event, and/or actuation of a panic button.

In at least one embodiment in accordance with any previous/other embodiment described herein, the at least one alarm indication comprises alarm metadata, the method further comprising correlating the content metadata and the sensor data with the alarm metadata to determine whether the at least one event has occurred.

In at least one embodiment in accordance with any previous/other embodiment described herein, the alarm metadata comprises at least one of a name of the at least one potential alarm, an instance identifier for the at least one potential alarm, a description of the at least one potential alarm, a timestamp associated with the at least one potential alarm, and an identification of a device having triggered the at least one potential alarm.

In at least one embodiment in accordance with any previous/other embodiment described herein, the sensor data comprises first sensor data and second sensor data, and the alarm metadata is correlated with the first sensor data and the content metadata is correlated with the second sensor data to determine whether the at least one event has occurred.

In at least one embodiment in accordance with any previous/other embodiment described herein, the sensor data comprises first sensor data and second sensor data, and the content metadata comprises first content metadata and second content metadata, the method further comprising at least one of correlating the first sensor data with the second sensor data and correlating the first content metadata with the second content metadata to determine whether the at least one event has occurred.

In at least one embodiment in accordance with any previous/other embodiment described herein, causing the at least one first action to be performed to mitigate the security issue comprises conducting, based on a correlation of sensor data from multiple sensors, a risk assessment to assign a risk level to the at least one alarm indication.

In at least one embodiment in accordance with any previous/other embodiment described herein, causing the at least one first action to be performed to mitigate the security issue comprises assigning, based on the risk assessment, a low risk level to the security issue, and outputting instructions to cause security personnel to be dispatched at the monitored site.

In at least one embodiment in accordance with any previous/other embodiment described herein, causing the at least one first action to be performed to mitigate the security issue comprises assigning, based on the risk assessment, a high risk level to the security issue, and outputting instructions to cause escalation of the security issue to an emergency service.

In at least one embodiment in accordance with any previous/other embodiment described herein, causing the at least one second action to be performed to mitigate the operational issue comprises outputting instructions to cause maintenance to be performed on the one or more media devices and/or the one or more sensors.

In accordance with another aspect, there is provided a system for analyzing an alarm. The system comprises a processing unit and a non-transitory computer-readable medium having stored thereon program instructions executable by the processing unit for obtaining at least one alarm indication associated with at least one potential alarm triggered at a monitored site, obtaining video data related to the at least one potential alarm, providing the video data to a machine learning model with one of first instructions for the machine learning model to identify whether at least one given event is depicted in the video data and to return a first response, and second instructions for the machine learning model to conduct a content analysis of the video data and to return a second response comprising one or more image embeddings each numerically representative of a content of the video data, and determining, based on one of the first response and the second response from the machine learning model, whether at least one incident corresponding to an alarm condition has occurred at the monitored site.

Many further features and combinations thereof concerning embodiments described herein will appear to those skilled in the art following a reading of the instant disclosure.

### DESCRIPTION OF THE FIGURES

In the figures,

FIG. 1 is schematic diagram illustrating an example security system, in accordance with one embodiment;

FIG. 2 is a schematic diagram of the alarm verification engine of FIG. 1, in accordance with an illustrative embodiment;

FIG. 3A is a flowchart illustrating an example method for alarm verification, in accordance with an illustrative embodiment;

FIG. 3B is a flowchart illustrating an example method for analyzing an alarm, in accordance with an illustrative embodiment; and

FIG. 4 is block diagram of an example computing device, in accordance with an illustrative embodiment.

It will be noticed that throughout the appended drawings, like features are identified by like reference numerals.

### DETAILED DESCRIPTION

Described herein are systems and methods for alarm verification in a surveillance system. The systems and methods described herein may be used for monitoring and surveillance, and more specifically for verification of alarm(s) generated within an area monitoring system (also referred to herein as a “surveillance system”). When an alarm is verified as being accurate, various security issue mitigations may be put into effect to address the security issue evidenced by the alarm. When an alarm is not verified, that is to say, found not to be accurate, an operational issue may be identified, and one or more operational issue mitigations may be put into effect.

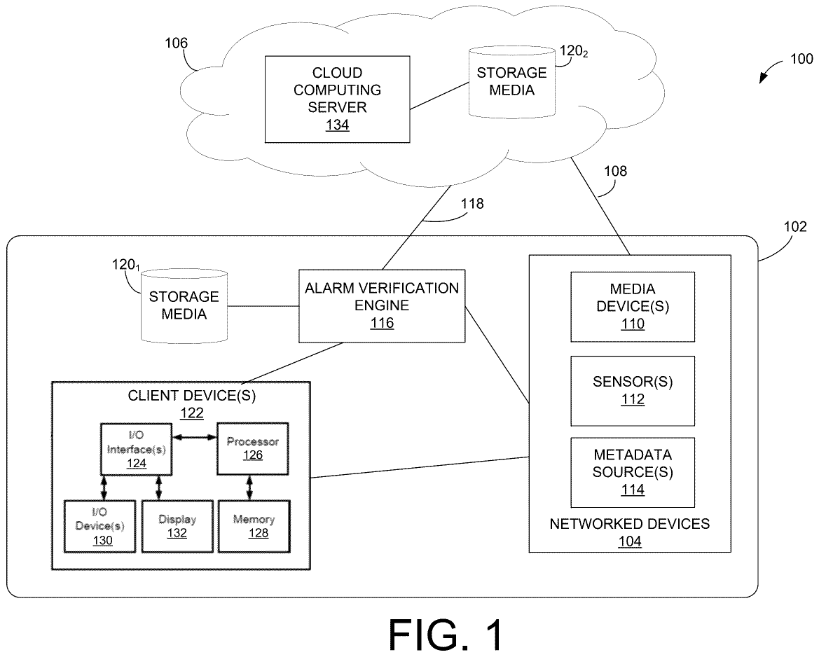

FIG. 1 shows an example of a security system 100, in accordance with one embodiment. While reference is made herein to the system 100 being a surveillance system used for security purposes (i.e., for reasons related to securing a given area), it should however be understood that the system 100 may be used for monitoring any other suitable activity or application, including, but not limited to, operational monitoring of various types, for example for monitoring public transport or traffic, monitoring retail sales locations, monitoring industrial and/or manufacturing processes, supply chain monitoring, etc. The system 100 may also be implemented or deployed in any suitable environment, including, but not limited to, a home, a business, a vehicle (e.g., a train, bus, or other mobile environment), and the like.

The system 100 comprises at least one local network 102 deployed at a location (or site) being surveilled. Although only one local network 102 is illustrated and described herein, it should be understood that the system 100 may comprise any suitable number of local networks as in 102, each deployed at a given location. In some embodiments, only one network 102 is provided, as illustrated in FIG. 1. In other embodiments, the system 100 is a distributed system comprising more than one network as in 102. For instance, a first network may be deployed at a first geographical location and a second network may be deployed at a second geographical location different from the first geographical location, with the first and second geographical locations forming part of a distributed site being jointly monitored. Each network 102 may comprise any suitable network including, but not limited to, a Personal Area Network (PAN), Local Area Network (LAN), Wireless Local Area Network (WLAN), Metropolitan Area Network (MAN), or Wide Area Network (WAN), or combinations thereof. In one embodiment, each network as in 102 is a LAN having a plurality of networked devices 104 placed thereon. In addition, each network as in 102 is communicatively coupled to a cloud-based computing infrastructure 106 which is configured to provide one or more cloud computing services to one or more components of the system 100, as will be described further below.

It should be understood that the system 100 may comprise a wide variety of different network technologies and protocols. Communication between the networked devices 104 may occur across wired, wireless, or a combination of wired and wireless networks. In addition to the networked devices 104 described below, the system 100 may include any number of devices such as routers, modems, bridges, hubs, switches, and/or repeaters, among other possibilities.

Still referring to FIG. 1, in some embodiments, the plurality of networked devices 104 may have direct network connectivity (i.e., are configured to directly connect, through a communication link 108) to the cloud-based computing infrastructure 106. In other embodiments, the plurality of networked devices 104 may not be configured to have such direct network connectivity and may only access the cloud-based computing infrastructure 106 via one or more other networked devices 104 (e.g., via one or more gateway devices, not shown) to which they are connected.

In one embodiment, the plurality of networked devices 104 comprises one or more media devices 110, one or more sensors 112, and one or more metadata sources 114. Although the metadata source(s) 114 are illustrated as being separate from the media device(s) 110 and the sensor(s) 112, it should be understood that the metadata source(s) 114 may, in some embodiment, be integral with the media device(s) 110 and/or the sensor(s) 112.

The media device(s) 110 and sensor(s) 112 may be fixed (i.e. stationary) or portable and deployed at the location being surveilled using the system 100. It should be understood that any suitable number of media devices 110 and sensors 112 may apply. When the system 100 comprises several media devices 110 and sensors 112, these may be located in close proximity to one another, for instance in the same building or on the same city block, or they may be remote from one another, for instance, located in different parts of the same city or in different cities altogether. Embodiments involving clusters of media devices 110 and/or sensors 112 may also be considered, where media devices 110 and/or sensors 112 belonging to one of a number of clusters may be geographically proximate to one another while the clusters themselves may be remote from one another.

The media devices 110 may be used to monitor objects, events, places, and/or people of interest within the location under surveillance. As a result of such monitoring, the media devices 110 generate media streams (i.e. a sequence of data elements produced over time), which may include image and/or video data and/or audio data, all referred to herein as “media stream data”. In some embodiments, the media stream data comprises one or more video streams (also referred to herein as “video feeds”) which may each comprise a plurality of images, and each image of the video stream may be referred to as a “frame”. The data elements forming a given media stream (e.g., a given video stream) may be produced in a continuous fashion, and, in some instances, in real-time or near real-time. The data elements (also referred to herein as “portions” of the media stream data) may be of various length, size, and/or time duration, depending on the implementation. In some cases, each portion of the media stream data may represent a single packet, a group of packets composing a single frame, a group of packets composing multiple frames, or the like. Thus, when used herein to refer to a portion of the media stream data, the term “portion” may encompass any suitable part or the entirety of a particular stream (e.g., video stream) forming the media stream data.

Any media stream data generated by the media devices 110 may further comprise one or more metadata items (also referred to herein as “metadata”), which might include, but is not limited to, an identifier associated with the media device 110 that generated the media stream, a timestamp, media content descriptors, auditing or integrity parameters, and the like. It should be understood that the media stream data generated by the media devices 110 may also comprise and/or have associated therewith text data indicative of various information including, but not limited to, transcripts, activity trails or records, entry/exit activity, badge sequences, measurements (e.g., temperature, pressure, or other measurements associated with relevant operating parameter(s) of the system 100), etc., which may be generated by the media devices 110 themselves, or by other devices (e.g., the sensors 112, the metadata sources 114) associated therewith, as will be described in greater detail hereinbelow. Although the present disclosure primarily focuses on embodiments in which the media devices 110 produce digital media stream data, it should be understood that embodiments in which the devices produce analog data which is converted to digital data are also considered. Additionally, in some embodiments the metadata items may be provided in a separate metadata stream that is associated with the media data stream. The metadata stream and the media data stream may be transmitted jointly, or separately, as appropriate.

The media devices 110 may provide the media stream data in real-time (or near real-time) or in non real-time. The media devices 110 may indeed generate media stream data and automatically transmit the generated data to other components of the system 100 in real-time (or near real-time). The media devices 110 may also comprise local storage (e.g., a local memory, not shown) in which the media stream data is stored. The media stream data may be stored within the system 100 in any suitable format, depending on the type of media stream data. In some embodiments, the media stream data may be stored in standards-compliant formats. In other embodiments, the media stream data may be stored in proprietary or custom formats. In embodiments in which the media stream data is provided in non-real time, the media devices 110 may thus comprise devices, such as network-attached storage media having media stream data recorded therein. It should therefore be understood that while reference is made herein to the media devices 110 being video cameras, this is for illustrative purposes only and any other suitable media device may apply. The media devices 110 may additionally or alternatively comprise devices which playback or otherwise provide previously recorded media stream data. Examples of such devices include, but are not limited to, hard drives, solid state drives, network-attached storage devices, cloud or other network-based storage systems, media center computers, general purpose computers, and the like. It should be understood that the group of media devices 110 may comprise devices of different types.

In some embodiments, the media devices 110 comprise devices configured to capture and/or manipulate images, video, and provide video-related functionality. Examples include, but are not limited to, surveillance cameras, dome cameras, pan, tilt, and zoom (PTZ) cameras, panoramic and multi-sensor cameras, desktop video cameras (i.e. webcams), dashboard cameras (dashcams), body wearable or body-worn cameras (bodycams), vehicle-mounted cameras, drone cameras, mobile telephone cameras, still image cameras, digital camcorders, etc. The media devices 110 may also comprise Internet Protocol (IP) cameras configured to send the media stream data via the network 102 they are placed in, which may, in this case, comprise an IP network. It should however be understood that the media devices 110 may comprise any other suitable image acquisition device. For example, the media devices 110 may comprise tire imaging cameras configured to take images of tires, where the tire images may be used in connection with tire tracks associated with an event under investigation. The media devices 110 may also comprise infrared (IR) thermal imaging devices used for flare monitoring (i.e. visual monitoring of a flare's behavior and state) in industrial (e.g., oil and gas) processes where flare stacks are used to burn unwanted waste gas byproducts and the like. For example, the IR thermal imaging devices may be configured to acquire images (e.g., videos and/or photos) as proof that the flare is burning continuously, and to obtain temperature readings of a flare stack or pilot flame.

The media devices 110 may also (or alternatively) comprise any other suitable device configured to acquire operational data and/or data related to physical security at the location where the system 100 is deployed. Thus, in addition to comprising image acquisition devices (e.g., cameras), the media devices 110 may include, but are not limited to, radars, audio microphones, video and/or audio encoders connected to analog device(s) or appliance(s), door stations, intercoms, Internet of Things (IoT) devices, and the like. The media devices 110 may also comprise license plate recognition (LPR) devices (e.g., LPR cameras) configured to provide license plate reads by capturing images of a vehicle around the license plate area. As used herein, the term “media stream data” may therefore be used to refer to any data generated by the media devices 110 in the process of monitoring or surveilling a location for any suitable purpose, for instance to ensure the security of persons or objects within the location, to ensure compliance with regulations or best practices, for traceability when performing processes or operations, and the like.

Still referring to FIG. 1, the sensor(s) 112 may comprise any suitable device or system configured to produce an output (also referred to herein as “sensor data”) in response to detecting event(s) or change(s) in its environment. This may include sensors used for area monitoring, traffic monitoring, defense monitoring, weather monitoring, and the like. The sensor(s) 112 may thus comprise, but are not limited to, motion sensors, glass breakage sensors, door contact sensors, window contact sensors, request to exit (REX) sensors, fire sensors, smoke sensors, sound sensors, infrared sensors, pressure sensors, tension sensors, magnetic sensors, temperature sensors, humidity sensors, and the like. The sensor(s) 112 may also comprise access control devices (e.g., card readers or keypads) configured to catalog events (also referred to as “access control events”) relating to access cards being read, access being granted or refused, and the changing status of a barrier (e.g., a door) or similar resource that controls access between locations and which has access control device(s) associated therewith. Any suitable sensor technology may apply.

Event(s) of interest may be associated with data acquired by the media device(s) 110 and sensor(s) 112 and stored in one or more data sources (e.g., in first storage media 120₁ and/or second storage media 120₂) as “occurrence records” (also referred to herein as “event occurrence records”). As used herein, the term “occurrence record” refers to information indicative of occurrence of an event stored or provided by a data source and that may be accessed or obtained from the data source. The data source may be or may comprise a database that stores occurrence records. The occurrence record has an occurrence record type (indicative of the nature or type of the event), and may have at least one time parameter (i.e. a parameter specifying time, such as a timestamp, a time interval, or a period of time, at or during which the event occurred) and at least one geographical parameter (i.e. a location, such as Global Positioning System (GPS) coordinates, a location range or distance, an area defined by a set of coordinates, or coordinates of a media device 110 and/or sensor 112 associated to the event, at or within which the event occurred). The occurrence record may have other metadata and data associated with additional parameters. The data structure of the occurrence record may depend upon the configuration of the data source and/or database in which the occurrence record is stored. Examples of occurrence records are surveillance video analytics, license plate reads associated with a time and geographical parameter, the identity of a registered criminal with a location of the criminal, 911 call events or computer-aided dispatch (CAD) events with a time parameter, geographical parameter, a narrative and/or a priority value, a gunshot event associated with the picking up of a sound that is identified to be a gunshot having a time parameter, a geographical parameter and the identification of the firearm, a traffic accident event with a time parameter and a location parameter, etc.

Still referring to FIG. 1, the one or more metadata sources 114 may comprise any suitable device or system configured to provide information (i.e. metadata) about events occurring at the location being surveilled by the system 100. In some embodiments, the metadata source(s) 114 comprise a video analytics system configured to process media stream data (e.g., received from the media device(s) 110). As used herein, the terms “video analytics,” “video analysis”, “video content analytics”, “video content analysis”, “content analytics”, and “content analysis” refer to one or more computer-implemented processes for analyzing media stream data (e.g., a video feed) to derive useful information about the contents thereof. The derived information may indicate various temporal and/or spatial events in the media stream data (e.g., the video feed) and may be used for any suitable application including, but not limited to, people counting, object detection, object identification, facial recognition, and automatic plate number recognition. For example, as a result of processing the video feed, the video analytics system may detect one or more objects and/or motion of the one or more objects at the location being surveilled using the system 100.

Conducting an analysis of the content of the media stream data, as described herein, may therefore result in the generation of metadata that may comprise, but is not limited to, metadata items about the media stream itself (e.g., data format, resolution, time of capture, location of capture, media device used for capture, and the like) and metadata items about the contents of the media stream, including, but not limited to, metadata items relating the presence of object(s) in the media stream (e.g., object type, object color, object location in the field of view of the media device, object direction of movement, object speed of movement, number of objects, and the like), metadata items relating to environmental factors visible in the media stream (e.g., weather type, lighting conditions, disaster elements, and the like), or other metadata items. The objects may, for example, include vehicles having given attribute(s) (e.g., type, color, make, model, etc.) and/or being vehicles of interest (e.g., license plate identifier matches a hitlist). The objects may also include persons performing specific action(s), exhibiting specific behavior(s), fitting a given description, and/or having given attribute(s) such as physical characteristic(s) (e.g., height, hair color, eye color, etc.), physical appearance (e.g., type of clothing, color of clothing, type of shoes, colors of shoes, glasses, tattoos, scars, carried objects, and any other identifying mark), or the like. The objects may also include registered persons of interest (e.g., registered criminals). Other embodiments may apply. Some metadata items may be used to derive other metadata items. For example, a succession of object location metadata items (i.e. successive locations of an object in the media device's field of view over a given period of time) may be used to determine the object's speed of movement. The metadata items may be stored in the first storage media 120₁ once generated.

While reference is made herein to metadata being generated based on the analysis of the media stream data (e.g., performed by the metadata source(s) 114), it should be understood that the media devices 110 may (instead or additionally) be configured to directly provide metadata items. In other words, some or all of the metadata items may be known to the source (i.e. the media device(s) 110 that generate the media stream data) and produced thereat. Indeed, the metadata may be provided by each media device 110 along with (e.g., as part of) or separate from the media streams generated by the media device 110. It should however be understood that, in some embodiments, the media devices 110 may only be configured to generate part of the metadata. In yet other embodiments, the media devices 110 may not be configured to generate any of the metadata. This may be the case, for example, when the media devices 110 have limited processing power or do not have the necessary tools (hardware and/or software) to produce analytics and generate metadata. In this case, the media devices 110 may then provide the media stream data they have generated, alongside any metadata they may be able to produce, to another device present on the local network 102 for the other device to analyze the media steam data to generate metadata relating to the content of the media stream data.

Still referring to FIG. 1, the system 100 also comprises an alarm verification engine 116 communicatively coupled to the media device(s) 110, the sensor(s) 112, and the metadata source(s) 114. In the illustrated embodiment, the alarm verification engine 116 has direct connectivity to the cloud-based computing infrastructure 106 (e.g., via communication link 118). The alarm verification engine 116 is communicatively coupled to the first storage media 120₁. The alarm verification engine 116 may also have indirect connectivity to the cloud-based computing infrastructure 106 (e.g., via one or more networked devices 104). Although illustrated as separate from the networked devices 104, it should be understood that the alarm verification engine 116 may be part thereof. In addition, although the networked devices 104 and the alarm verification engine 116 are illustrated as being provided on the same (i.e. common) local network 102, it may, in some embodiments, be suitable for the alarm verification engine 116 to be provided in the cloud-based computing infrastructure 106. It may also be suitable for the alarm verification engine 116 to be provided on a local network different from the local network 102 on which the networked devices 104 are provided. The alarm verification engine 116 may be provided at a centralizing location, such as at a local network different from the local network 102 which manages a plurality of subnetworks.

As will be described further below, the alarm verification engine 116 is configured to receive alarm indication(s) which provide evidence of situations which might warrant triggering of an alarm associated with the location being surveilled, validate (i.e. confirm or reject) the alarm indication(s), identify a type of issue (i.e. security issue or operational issue, as will be described further below) associated with the alarm indication(s), and determine one or more actions to be taken in order to mitigate the identified issue.

As used herein, the term “alarm” refers to a signal (e.g., visual and/or audible) that serves to warn, inform, or otherwise alert a user to a condition requiring immediate attention or action. As will be described further below, the alarm may be an actual alarm, which is indicative of the actual presence or existence of an undesirable or anomalous condition, or an alarm which is be erroneously triggered (also referred to herein as a “false alarm”, a “tentative alarm” or a “potential alarm”), meaning that no undesirable or anomalous condition exists or is present. When an alarm is triggered, whether an actual alarm or a potential alarm, a corresponding alarm indication (e.g., a notification in any suitable format) is received by the system 100 to indicate that the alarm was triggered and needs to be verified (i.e. confirmed or rejected). Without the process implemented by the alarm verification engine 116 to validate alarm indication(s), the alarm indication(s) would result in an alarm being raised with the system 100. Thus, as used herein, an “alarm” corresponds to the last step in informing a user of a situation warranting their response.

Alarms may be triggered by a component of the system 100 or a third-party system coupled to the system 100, based on certain conditions, which may be defined by the user. For example, alarms may be triggered in response to events or incidents (referred herein as “trigger events”) detected by any suitable component of the system 100 including, but not limited to, the media device(s) 110 and the sensor(s) 112. Examples of trigger events that can cause the triggering of an alarm include, but are not limited to, the triggering of an alarm in response to a door opening event (e.g., a door forced open or a door held open event), an access denied (e.g., invalid badge) event, a glass/break event (e.g., a broken window), a gas leak event, a fire, a gunshot event (e.g., a gunshot notification from a gunshot detector), a motion-based event (e.g., sudden egress or group forming), a person detected event (e.g., presence of an unauthorized person, loitering, and/or tailgating), a vehicle detected event, an object detected event, a stolen car event, and actuation of a panic button). It should be understood that an alarm may be triggered by more than one (i.e. a combination of) trigger events. For example, an alarm may be triggered as a result of an access denied event followed by a door opening event and a person detected event.

In some embodiments, each media device 110 and each sensor 112 may be configured to trigger an alarm in response to detecting the trigger event(s) based on the acquired media stream data or the sensor data. For example, a motion sensor disposed within an establishment may be armed upon closing of the establishment. When the motion sensor is later tripped by the presence of an unauthorized person within the establishment, the motion sensor may raise an alarm within the broader security system at the establishment, which includes the system 100. In another example, when a person not authorized to access a restricted area attempts to badge-in at a door to access the restricted area, the access control device coupled to the door may raise an alarm (resulting from detection of an access denied event), which may in turn cause the generation of media data comprising video footage of the security camera facing the door.

In other embodiments, the alarm verification engine 116 may be configured to receive raw data (e.g., media stream data from the media device(s) 110 and/or sensor data from the sensor(s) 112), to analyze the received data in order to evaluate whether trigger event(s) have occurred, and to trigger the alarm upon detection of the trigger event(s). In yet other embodiments, the cloud computing server 134 may be configured to trigger an alarm based on the media stream data received from the media device(s) 110 and/or the sensor data received from the sensor(s) 112. A third-party system, such as a fire system coupled to the system 100 or a system configured to manage the system 100, may also be configured to trigger an alarm based on user-defined conditions.

In one embodiment, one or more alarm metadata items (also referred to herein as “alarm metadata”) are generated (e.g., by the system 100) when an alarm is triggered. The metadata item(s) may comprise the alarm name, the alarm instance identifier, the description of the trigger event associated with the alarm, information about sensor(s) having triggered the alarm, and a timestamp associated with the alarm. The alarm metadata may be generated in any suitable format, including but not limited to a textual format. The alarm metadata may be provided to component(s) of the system 100 (e.g., to the alarm verification engine 116) in real-time, as the alarm metadata is generated, or may be stored in memory (e.g., the first storage media 120₁ and/or the second storage media 120₂) for subsequent access.

Still referring to FIG. 1, in one embodiment, the system 100 further comprises client device(s) 122 in communication with the networked devices 104 and the alarm verification engine 116. One or more client devices 122 may be provided, in close proximity to one another, for instance located in the same office or data center, or remote from one another, for instance located in different offices and data centers dispersed across the same city or in different cities altogether. Each client device 122 may be a remote computing device (i.e. functioning as a client) that comprises a plurality of components interconnected via bus connections and the like. In the illustrated example, each client device 122 comprises I/O interface(s) 124, at least one processor 126, at least one memory 128, I/O device(s) 130 (e.g., a keyboard, a mouse, a touchscreen, etc.), and at least one display device 132 (e.g. a screen, a tactile display, etc.). The client device 122 may be a desktop computer, a laptop, a smartphone, a tablet, etc.

A client application program may be stored in the memory 128 of each client device 122, the client application program providing the user with an interface to interact with the alarm verification engine 116. In some embodiments, the alarm verification engine 116 is part of a video management system (VMS, not shown), a security device management system, or the like, and the client application program may be configured to interface with such a system. In some embodiments, the alarm verification engine 116 may be connected to at least one client device 122, where, for instance, the connection between the alarm verification engine 116 and the client device 122 may be a wired connection. In some embodiments, the functionality of the alarm verification engine 116 and the client device 122 may be implemented on a single computing device.

The client device 122 may be operated by authorized user(s) to access, view, process, edit, and/or analyze information which may comprise video information, such as a video feed (e.g., as generated by the media device(s) 110), sensor information (e.g., as generated by the sensor(s) 112), metadata (e.g., as generated by the metadata source(s) 114), alarm verification information (e.g., as generated by the alarm verification engine 116), as well as any other relevant information. The client device 122 may be configured to launch a video playback application, a web browser, or a web application (not shown) that renders a graphical user interface (GUI) on the display device 132. The GUI may be used to display outputs and accept inputs and/or commands from user(s) of the client device 122. The GUI may further provide user(s) with the ability to view and/or edit information (e.g., video feeds), as well as be presented information of interest (e.g., related to the video feeds).

Still referring to FIG. 1, the cloud-based computing infrastructure 106 is configured to run part of the workload of components of the system 100 in the cloud. In particular, the cloud-based computing infrastructure 106 may provide any suitable cloud computing service(s) related to management of the system 100 including, but not limited to, processing of media stream data, cloud archiving or storage of media stream data, storage of video indexes, off-network live video requests and viewing, video analysis, indexing and persisting metadata for applications such as forensic search, live video camera health monitoring, alert scheduling, bandwidth management, or other form of processing and/or management related to the media stream data. For this purpose, in one embodiment, the cloud-based computing infrastructure 106 comprises a cloud computing device (referred to herein as a “cloud computing server”) 134. The cloud computing server 134 may comprise one or more virtual processors configured to process data (e.g., media stream data) upon receipt thereof and cause the cloud computing service(s) to be provided.

Second storage media (i.e. cloud-based storage media) 120₂, is provided in the cloud-based computing infrastructure 106 and is communicatively coupled to the cloud computing server 134. The storage media 120₁, 120₂ may each comprise a suitable device or medium (i.e. a computer-readable medium) configured for storing data in a format readable by a processor or other computing device. The storage media 120₁, 120₂ may, in some embodiments, be one or more servers comprising one or more databases. For example, the storage media 120₁, 120₂ may be implemented as distributed storage (e.g., as a collection of one or more distributed servers). As noted herein above, in one embodiment, the second storage media 120₂ is part of a cloud-based storage service, such as Microsoft® Azure®, Amazon® AWS®, or a similar cloud-based storage service offered by another provider. As also noted herein above, in one embodiment, the first storage media 120₁ is provided on the local network 102. In this case, the first storage media 120₁ comprises local storage while the second storage media 120₂ comprises cloud-based storage media. In another embodiment, the first storage media 120₁ is a cloud-based storage media that is part of a cloud-based storage service such that both the first storage media 120₁ and the second storage media 120₂ comprise cloud-based storage. In yet other embodiments, the first storage media 120₁ may be an abstraction of several layers of storage, which may include local storage, cloud storage, network storage, or any suitable combination thereof.

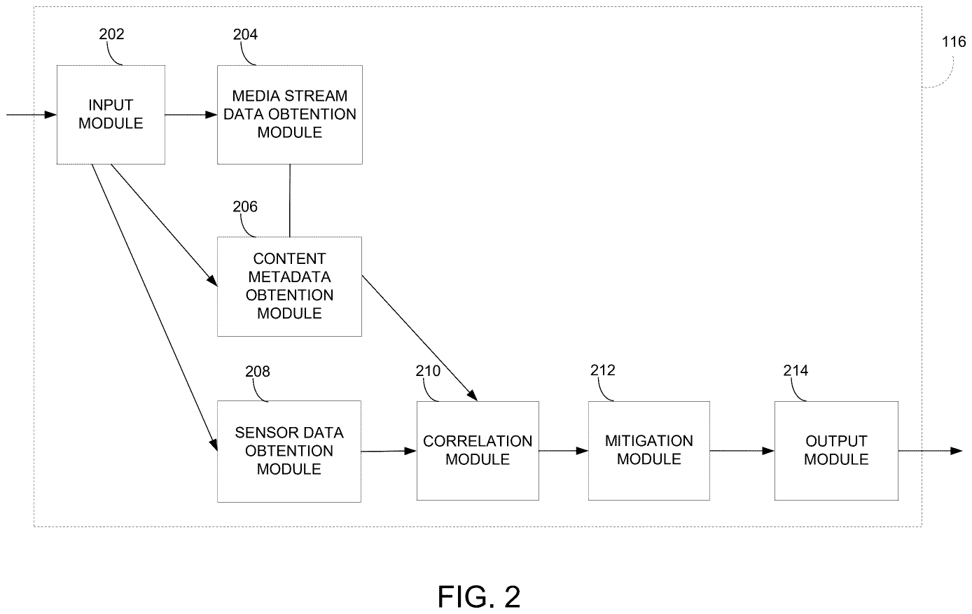

Referring now to FIG. 2 in addition to FIG. 1, the alarm verification engine 116 comprises an input module 202, a media stream data obtention module 204, a content metadata obtention module 206, a sensor data obtention module 208, a correlation module 210, a mitigation module 212, and an output module 214.

The input module 202 is configured to receive input data from various components of the system 100. As such and as will be described further below, the input data received by the input module 202 may comprise, but is not limited to, alarm indication(s) (and associated alarm metadata), media stream data generated by the media device(s) 110, sensor data generated by the sensor(s) 112, metadata information from the metadata source(s) 114 (or any other suitable component of the system 100), data (e.g., commands, requests, or the like) received from a user via the client device(s) 122, and other relevant data obtained from one or more other components of the system 100.

In particular, the alarm verification engine 116 is configured to obtain, via the input module 202, at least one alarm indication associated with one or more alarms triggered at the location being surveilled. As previously noted, the alarm indication(s) may be representative of actual alarm(s) associated with event(s) or incident(s) corresponding to actual alarm condition(s) (i.e. undesirable or anomalous events) or false alarm(s), meaning that no event corresponding to an alarm condition (i.e. no incident) occurred at the monitored location or site. The alarm indication may be triggered by a component of the system 100 or a third-party system coupled to the system 100, in response to detection of one or more of the trigger events described herein above. In one embodiment, the alarm indication is obtained in real-time, concurrently with the triggering of the alarm, such that the analysis of the alarm indication for verification purposes (as described herein) is performed in real-time. In other embodiments, after the alarm is triggered, the corresponding alarm indication may be stored in memory (e.g., in the first storage media 120₁ and/or the second storage media 120₂) along with relevant information about the alarm (e.g., alarm metadata items). The alarm verification engine 116 may subsequently retrieve the alarm indication and the corresponding alarm metadata from memory in order to verify the alarm ex post facto for any suitable purpose (e.g., for audit purposes).

Following receipt of the alarm indication, the media stream data obtention module 204 is configured to obtain media stream data captured by the one or more of the media device(s) 110 for use in validating the alarm indication (and accordingly the potential alarm). This may be achieved by querying the first storage media 120₁ and/or the second storage media 120₂ to retrieve the media stream data therefrom. In particular, the media stream data may be obtained from the event occurrence records. Alternatively, the media stream data obtention module 204 may query the media device(s) 110 to obtain the media stream data directly therefrom. In one embodiment, the media stream data obtention module 204 may be configured to obtain media stream data acquired by all media device(s) 110 deployed at the location being surveilled, for a given timeframe encompassing the time at which the alarm corresponding to the alarm indication was triggered.

In another embodiment, the media stream data obtention module 204 may be configured to obtain media stream data from a subset of the media device(s) 110. In particular, the media stream data obtention module 204 may first obtain media stream data from a first media device 110 positioned adjacent a target location (e.g., a nearby camera pointed at a door where an alarm was triggered). The alarm verification engine 116 may then use the media stream data obtain from the first media device 110 to determine whether an event corresponding to an alarm condition (also referred to herein as an incident) has occurred (in the manner described further below). Should this assessment prove inconclusive, the media stream data obtention module 204 may be configured to identify one or more additional media devices 110 from which to obtain media stream data for alarm verification purposes. The additional media device(s) may be determined based on any suitable predetermined selection criteria. For example, the selection criteria may be distance-based, such that all media devices 110 within a certain radius of the first media device 110 are selected as additional media devices. In other words, the identification of the media device(s) 110 form which the media stream data is obtained may be based on a distance between the position or location (e.g., the geographical position) of the media device(s) 110 and the location where the alarm was triggered. The selection criteria may however be based on any other parameter including, but not limited to, the direction of movement of target object(s). For example, if it is determined, based on the media stream data obtained from the first media device 110, that an object is being displaced in a given direction, the alarm verification engine 116 may be configured to select as additional media devices all media devices 110 positioned along the given direction. In yet another embodiment, the media stream data obtention module 204 may be configured to retrieve from memory (e.g., from the first storage media 120₁ and/or the second storage media 120₂) topological data associated with the monitored location in order to identify the relevant media device(s) 110. Other embodiments may apply.

Still referring to FIG. 2 in addition to FIG. 1, the content metadata obtention module 206 is configured to obtain content metadata associated with the media stream data obtained by the media stream data obtention module 204. In one embodiment, this may be performed using any suitable machine learning technique or model in communication with (or implemented by) the alarm verification engine 116. In particular, the content metadata obtention module 206 may be configured to execute or query a machine learning model to conduct a content analysis of the media stream data and generate metadata items (as described above) about the contents of the media stream data. It should however be understood that the content metadata may additionally or alternatively be obtained from the media device(s) and/or from the metadata source(s) 114 (e.g., via the input module 202).

A machine learning model described herein may be trained in any suitable manner, using any suitable training data and a suitable optimization process to minimize a loss function. In one embodiment, the machine learning model may be trained in advance prior to the deployment of the system 100. In other embodiments, the machine learning model may be trained in real-time, based on live data (e.g., provided by a user via their client device 122). Still other embodiments may apply. For instance, a hybrid approach of training the machine learning model partly in advance and partly in real-time may be used. Furthermore, the parameters of the machine learning model may be continuously tuned to improve the model's accuracy, for example by enhancing the data fed as input to the model. Machine learning refinement may occur at different stages of the model and at different time points (e.g., using feedback to refine the machine learning model after deployment of the system 100).

The machine learning model, once trained, is configured to perform a particular task including, but not limited to, image classification (e.g., assigning a classification to an image or to objects in the image), object detection or identification (e.g., detecting the presence and the location of different types of objects in an image), semantic interpretation (e.g., understanding the meaning of text, such as a CAD call narrative), and interpretation of sensor data such as sound, access control events, etc. Thus, the results produced by the machine learning model include an outcome of the particular task for which the machine learning model is trained. The results (e.g., analysis results, recommendations and/or suggestions) may be provided in any suitable format including, but not limited to, text, image embeddings, or the like. In one embodiment, the machine learning model is configured to provide its results for subsequent validation by a human operator at a particular time before decisions are made.

In one embodiment, the machine learning model comprises one or more multimodal models trained to receive as input images and/or text (whether written or in some other form) and to perform tasks based on the input. In one embodiment, the multimodal model is trained to accept visual content (e.g., image data), to identify object(s) within the visual content, and to provide information (e.g., a description in textual format) about the identified object(s). For example, the multimodal model executed by the content metadata obtention module 206 may be trained to accept a video feed captured by a media device 110, or one or more frames taken therefrom, and to output a textual description of (e.g., a freeform response describing) one or more scenes depicted in the video feed. In another embodiment, the multimodal model is a large language model (LLM) module trained to accept input text and to provide information based on the input text. For example, the LLM module may be trained to accept one or more prompts in the form of one or more questions and to provide responses to the question(s) in textual format. The questions may be generated based on the alarm indication (and associated alarm metadata) received via the input module 202. Any combination of broad questions and narrow questions may be used. Broad questions may, for example, entail asking what the LLM module detects in the video feed (e.g., “What do you see in this video?”). Narrow questions may, for example, entail asking the LLM module specific questions about the video feed (e.g., “Do you see a door being opened for more than five seconds?” or “Do you see more than ten people in this video?”). The LLM module may then provide its response in any suitable format, such as a “Yes”/“No” (or “True”/“False”) answer, a binary output (e.g., “1” corresponding to “Yes” or “True” and “0” corresponding to “No” or “False”), or one or more words or sentences (e.g., a text describing a scene depicted in the video feed).

In some embodiments, the machine learning model has image embedding capabilities and/or textual embeddings capabilities. As used herein, the terms “image embedding” and “textual embedding” refers to a numerical representation of an image or of text that encodes information representative of the contents of the image or of the text, respectively. The machine learning model is trained to accept images as input and to create, for each image, an image embedding indicative of a content of the image. For this purpose, the machine learning model may be trained using multiple training datasets each comprising an image and associated text semantically describing the contents of the image. The image embeddings may be generated in response to the machine learning model being prompted with one or more questions, as described above. The image embeddings can then be output by the content metadata obtention module 206 for subsequent use in validating the alarm condition. It should be understood that, in some embodiments, the machine learning model may not employ image embeddings to achieve the methods described herein.

Still referring to FIG. 2, the sensor data obtention module 208 is configured to obtain the sensor data generated by the sensor(s) 112, for subsequent correlation (by the correlation module 210) of the sensor data with the content metadata associated with the media stream data. The sensor data obtention module 208 may be configured to use any suitable means to identify the sensor(s) 112 from which to obtain the sensor data. In one embodiment, the sensor data obtention module 208 is configured to retrieve from memory (e.g., from the first storage media 120₁ and/or the second storage media 120₂) topological data associated with the monitored location in order to identify one or more sensors 112 of interest. As used herein, the term “topological data” is data which represents a layout of spaces and/or of the relationships between areas and spaces (e.g., rooms) to be monitored and of a manner in which the sensor(s) 112 are arranged within the monitored areas (e.g., locations of the sensor(s) 112). In other words, the topological data corresponds to a logical expression of the proximity between spaces or devices (e.g., media device(s) 110 and/or sensor(s) 112) deployed at the monitored location. The topological data may be provided in any suitable format including, but not limited to, a textual description and a logical topological tree. In one embodiment, the topological data comprises eXtensible Markup Language (XML) data.

Based on the topological data, the sensor data obtention module 208 may determine which sensor(s) 112 are relevant to the alarm under verification. Once the relevant sensor(s) 112 have been identified, the sensor data obtention module 208 is configured to obtain the associated sensor data in any suitable manner. In one embodiment, the sensor data obtention module 208 the sensor data directly from the identified sensor(s) 112. In another embodiment, the sensor data obtention module 208 queries a memory or database (e.g., event occurrence records stored in the first storage media 120₁ and/or the second storage media 120₂) to obtain therefrom the sensor data acquired by the identified sensor(s) 112.

The correlation module 210 is configured to correlate different datasets in order to assess whether event(s) corresponding to an alarm condition occurred at the monitored location, and to determine one or more actions to be performed next based on the assessment. This may be performed in any suitable manner and using any suitable technique. In some embodiments, the correlation may be performed using a suitable machine learning technique or model, which may be the same as or different from the machine learning model executed by the content metadata obtention module 206. In one embodiment, the correlation module 210 correlates the alarm metadata with the content metadata associated with the media stream data (e.g., as obtained by the content metadata obtention module 206 executing the machine learning model described above) and the sensor data (obtained by the sensor data obtention module 208) in order to determine whether both sets of data are consistent. For example, the correlation module 210 may correlate alarm metadata, which is indicative that a fire event is associated with the alarm, with content metadata, which provides a scene description a fire burning at the monitored location, and with data captured by a smoke sensor, which indicates that smoke has been sensed at the location. The correlation module 210 may then determine, based on the correlation, that the alarm metadata, the content metadata, and the sensor data are consistent with one another. The correlation module 210 may thus validate the alarm based on the correlation.

In some embodiments, the correlation module 210 may be configured to alternatively or additionally perform the correlation using different sets of metadata, different sets of sensor data, or a combination thereof. The correlation module 210 may indeed be configured to validate the alarm indication by correlating different sensor inputs, with a first set of sensor data being used to ascertain the alarm indication and a second set of sensor data being correlated with the content metadata to obtain the final alarm validation. Continuing with the previous fire alarm example, the correlation module 210 may first correlate the alarm indication with sensor data obtained from the smoke sensor. If the smoke sensor data indicates that smoke has been sensed, the correlation module 210 may determine that the fire event did occur and that the alarm is valid. To further verify this conclusion, the correlation module 210 may then correlate the alarm indication with second sensor data obtained from a temperature sensor deployed at the monitored location. If the temperature sensor data indicates that the temperature at the monitored location has reached or exceeded a predetermined temperature (e.g., flame temperature), the correlation module 210 may confirm that the alarm is valid because the first and second sensor data is concurring (i.e. in agreement) to validate the fire event.

The correlation module 210 may also be configured to validate the alarm indication using different sets of metadata. Continuing with the previous fire alarm example, the correlation module 210 may be configured to perform the correlation based on first content metadata obtained from a first camera deployed at the monitored location and second content metadata obtained from a second camera deployed at the monitored location. The first content metadata may provide a scene description a fire burning (as seen from a first angle and captured by the first camera) and the second content metadata may provide a scene description of an unauthorized person deliberately setting the fire (as seen from a different angle and captured by the second camera). Based on a correlation of the first content metadata with the second content metadata, the correlation module 210 may conclude that the first and second sets of content metadata are concurring to validate the fire event. The correlation module 210 may thus confirm that the alarm is valid.

Although reference is made herein to the correlation module 210 being configured to correlate different sets of data for the purpose of validating an alarm indication, it should be understood that correlation between metadata from different sources may, in some embodiments, be performed separate from (e.g., prior to) the validation of the alarm indication. For instance, the correlation between different sets of metadata may lead to generation of the initial alarm indication, which is received by the alarm verification engine 116.

In some embodiments, the correlation module 210 may perform the correlation at a textual level, between different sets of data obtained in a textual format. For example, the textual output (e.g., a scene description) provided by the machine learning model (e.g., the LLM module) may be correlated with alarm metadata items provided in a textual format. For this purpose, the correlation module 210 may feed the textual description of the scene and the alarm metadata to a text analyzer configured to perform an analysis of the input texts. The analysis may be performed to determine whether a similar incident is described in the two input texts. This may entail performing a keyword search to find predetermined keywords (e.g., “door opened”) or to identify a prevalence of predetermined terms in the input texts. In some embodiments, the correlation between two or more input texts may be done using an LLM module in order to accurately correlate a scene description to alarm descriptions. Other embodiments may apply.

In other embodiments, the correlation module 210 may perform the correlation using image embeddings obtained from the content metadata obtention module 206. The correlation module 210 may be configured to correlate the image embeddings and the alarm metadata with reference data (e.g., retrieved from the first storage media 120₁ and/or the second storage media 120₂). The reference data may comprise reference numerical data, such as reference image embeddings, associated with different types of events, where each reference image embedding is indicative of a given type of event associated therewith. The correlation module 210 may be configured to correlate the alarm metadata with the reference data to identify reference image embeddings that match the trigger event indicated (in the alarm metadata) as having caused the alarm. The correlation module 210 may be further configured to compare the reference image embeddings to the image embeddings obtained from the content metadata obtention module 206 in order to determine the extent to which both sets of image embeddings are numerically similar. If the degree of similarity between the sets of image embeddings is at or above a predetermined similarity threshold, the correlation module 210 determines that an event corresponding to an alarm condition actually occurred and validates the alarm. Otherwise, if the degree of similarity between the sets of image embeddings is below the similarity threshold, the correlation module 210 determines that no event corresponding to an alarm condition occurred and rejects the alarm.

Based on the outcome of the correlation performed by the correlation module 210, the mitigation module 212 determines whether the alarm indication is related to a security issue or an operational issue, and identifies one or more actions to be performed depending on the issue. This may be performed using any suitable machine learning technique or model, which may be the same as or different from the machine learning model executed by the content metadata obtention module 206 and the correlation module 210. As used herein, the term “security issue” refers to an issue or event that puts the integrity, availability, or confidentiality of an organization's assets (e.g., facilities, equipment, resources, and/or personnel) or data at risk. A security issue is detected upon determining that the alarm is valid and that at least one event corresponding to an alarm condition has occurred. As used herein, the term “operational issue” refers to an issue or event that puts the good-functioning, reliability, or consistency of the organization's processes or operations at risk. Examples of operational issues include, but are not limited to, a water spill that needs to be cleaned up, an access control device that is about to fail and needs to be replaced, a camera lens that needs to be cleaned, or an entry door that is blocked. An operational issue is detected upon determining that the alarm is invalid and that no event corresponding to an alarm condition has occurred (e.g., a false alarm was triggered).

When a security issue is detected, the mitigation module 212 is configured to perform security mitigation, which comprises any suitable action(s). For example, the mitigation module 212 may cause a risk assessment to be performed in order to determine whether the alarm condition requires the dispatch of security personnel at the monitored location or requires the security issue to be escalated for handling by another system. The risk assessment may comprise determining a risk level associated with the alarm condition, based on media stream data obtained from the media device(s) 110, sensor data obtained from the sensor(s) 112, any other suitable data generated within the system 100, and/or based on risk guidelines established by the organization operating the site being monitored. The risk level relates to the degree to which the alarm condition is deemed to put the organization having deployed the system 100 at risk. The risk level may, in some embodiments, be quantitative and expressed in numerical terms, as a value from a range of values (e.g., a value on a scale from 0 to 10, a value on a percentage scale, etc.). The risk level may, in other embodiments, be qualitative and expressed using a qualitative measure such as “low”, “moderate”, or “high”. For example, a risk level greater than or equal to a predetermined threshold may be referred to as “high”, whereas a risk level lower than the threshold may be referred to as “low”. Other embodiments may apply.

In one embodiment, in order to assign a risk level to the alarm condition, the mitigation module 212 may be configured to determine (e.g., using pattern recognition or any other suitable technique) whether multiple sensors 112 deployed at the monitored location are concurring (i.e. different sets of sensor data indicate that a security issue is present) or discording (i.e. some sets of sensor data indicate that a security issue is present while other sets of sensor data indicate the opposite). Alternatively or additionally, the mitigation module 212 may be configured to assign the risk level based on an assessment as to whether different sets of content metadata (associated with media stream data acquired from different media device(s) 110) are concurring or discording. For example, the mitigation module 212 may compare a scene description of a video feed acquired by a first camera positioned on one side of an access-controlled door to a scene description of a video feed acquired by a second camera positioned on the other side of the door. When the mitigation module 212 determines that the different sets of sensor data or content metadata are concurring, a high risk level (i.e. above a predetermined threshold) may be assigned to the alarm condition.

When the mitigation module 212 determines that the different sets of sensor data or content metadata are discording, a low risk level (i.e. below the threshold) may be assigned to the alarm condition. When the risk level is low, the mitigation module 212 may cause the dispatch of security personnel (e.g., a security guard) at the monitored location by providing, to the output module 214, one or more control signals comprising instructions for causing the dispatch. The output module 214 may render the instructions on an output device (e.g., on the display 132 of the client device 122), in any suitable manner to cause the dispatch to occur. The security personnel may then be alerted (e.g., via the display 132) and may respond accordingly. For a high risk level, the mitigation module 212 may cause escalation of the security issue (e.g., to an emergency service such as a police station, a fire department, an ambulance service, or the like), by generating an alert for presentation (e.g., via the output module 214) on the client device 122 or in any other suitable manner. It should be understood that the particular mitigation deployed for a given alarm may also vary based on the nature of the alarm, as well as based on the risk level associated with the alarm. For instance, the appropriate mitigation for a low-level risk for a tailgating alarm may be dispatching a member of the security personnel, whereas the appropriate mitigation for a low-level risk for a fire alarm may be to contact emergency services.

When an operational issue is detected, the mitigation module 212 is configured to perform operational mitigation, which may comprise any suitable action(s) including, but not limited to, actions that are part of a standard operating procedure (SOP) for equipment maintenance management, signaling the operational issue to a relevant stakeholder, storing a record of the operational issue in a relevant database, or the like. For example, the mitigation module 212 may cause maintenance personnel to be dispatched to the monitored location in order to respond to the reasons for which the alarm condition was received and the alarm was triggered. This may be achieved by the mitigation module 212 providing, to the output module 214, one or more control signals comprising instructions for causing the dispatch. The output module 214 may then render the instructions on the output device to alert the maintenance personnel which may respond by performing maintenance on the media device(s) 110 and/or on the sensor(s) 112. For example, a maintenance technician may be dispatched to the monitored location to fix or replace a faulty sensor that resulted in the triggering of a false alarm. Other embodiments may apply.

According to one non-limiting example, the system 100 may be used for Door-Forced-Open (DFO) alarm verification. As understood by those skilled in the art, an access-controlled door is coupled to various devices which are connected (e.g., through a control panel located at or nearby the door) to an access control system having door monitoring features. The devices typically comprise electric lock hardware (e.g., electric locks, electromagnetic locks, electric strikes, etc.) configured to lock or unlock the door, a door position switch (e.g., a magnetic contact switch) indicating whether the door is open or closed, a card reader (e.g., a magnetic stripe reader, a smartcard reader, a proximity reader, etc.) provided on an outside (or non-secured) side of the door, and a REX device (e.g., a manual REX button, a REX motion detector, a REX switch on lock hardware, etc.) provided on an inside (or secured) side of the door.

When an authorized user attempting to enter through the door from the outside presents a valid card at the card reader, the access control system authorizes entry (by sending a control signal to the electric lock hardware to cause the door to unlock) and no DFO alarm is triggered as the user opens the door. Similarly, when the authorized user approaches the door from the inside to exit and activates the REX device (e.g., presses the manual REX button or presses a door exit bar inside which a REX switch is provided), the access control system authorizes exit (because the REX device was activated) and no DFO alarm is triggered as the user opens the door. However, if the door is opened without the use of a valid access card or the activation of the REX device, the access control system may assume that the door is being forced open and thus trigger a DFO alarm. This is due to the fact that the access control system will have received a signal from the door position switch (indicating that the door has been opened) without having received a previous signal from the card reader (indicating that a valid access card was presented thereat) or the REX device. The DFO alarm may however prove to be a false alarm that was triggered in error for various reasons. For instance, the DFO alarm may be unduly triggered due to improper latching of the door, malfunctioning of the lock hardware, door position switch, card reader, and/or REX device, improper settings of the REX device (e.g., excessively long time delay settings on REX motion detector), improper coverage of the REX device (e.g., REX motion detector creating a blind spot in front of the door), users forgetting to use the REX device (e.g., forgetting to press the manual REX button), etc.

The system 100 may be used to validate a DFO alarm in order to determine whether it is an actual DFO alarm or a false DFO alarm. For example, the system 100 may receive an alarm indication associated with a DFO alarm triggered by the door position switch. The DFO alarm may be a valid alarm related to a security issue (i.e. the occurrence of an actual DFO condition, e.g., resulting from an intruder prying the door open from the outside) or an invalid (or false) alarm related to an operational issue (i.e. a malfunctioning door position switch that incorrectly indicates that the door has been opened). In order to verify the DFO alarm, the system 100 (i.e. the alarm verification engine 116) is configured to obtain media data captured by at least one of the media device(s) 110 deployed at the monitored location. For instance, the alarm verification engine 116 may obtain the video feed from a video camera positioned nearby the access-controlled door. The alarm verification engine 116 then executes the machine learning model described herein to conduct a content analysis of the media data. In one embodiment and as described herein above, the alarm verification engine 116 may execute a machine learning model to obtain a textual description of one or more scenes depicted in the video feed. In another embodiment, the alarm verification engine 116 may prompt the machine learning model (e.g. an LLM module) with one or more questions (e.g., broad and/or specific questions, as described above) in order to assess whether the video feed depicts the door being opened, and the machine learning model returns answers to the questions in a textual format. In the case where a false DFO alarm was triggered, the machine learning model may provide a textual answer indicating that no people were present at or near the door when the DFO alarm was triggered.

The alarm verification engine 116 further obtains data from at least one of the devices (other than the door position switch) coupled to the access controlled-door. For example, the alarm verification engine 116 may obtain, from the lock hardware, data indicating the status (i.e. locked or unlocked) of the door. Continuing with the case where a false DFO alarm was triggered, the lock hardware data may indicate that the door remained locked at the time the DFO alarm was triggered. Upon correlating the sensor data with the output provided by the machine learning model, the alarm verification engine 116 may then determine that the DFO alarm was falsely triggered and detect that the DFO alarm relates to an operational issue (i.e. malfunctioning door position switch) which requires attention. The alarm verification engine 116 may thus cause one or more actions (e.g., the dispatching of maintenance personnel at the monitored location to fix or replace the malfunctioning door position switch) to be performed to mitigate the operational issue.

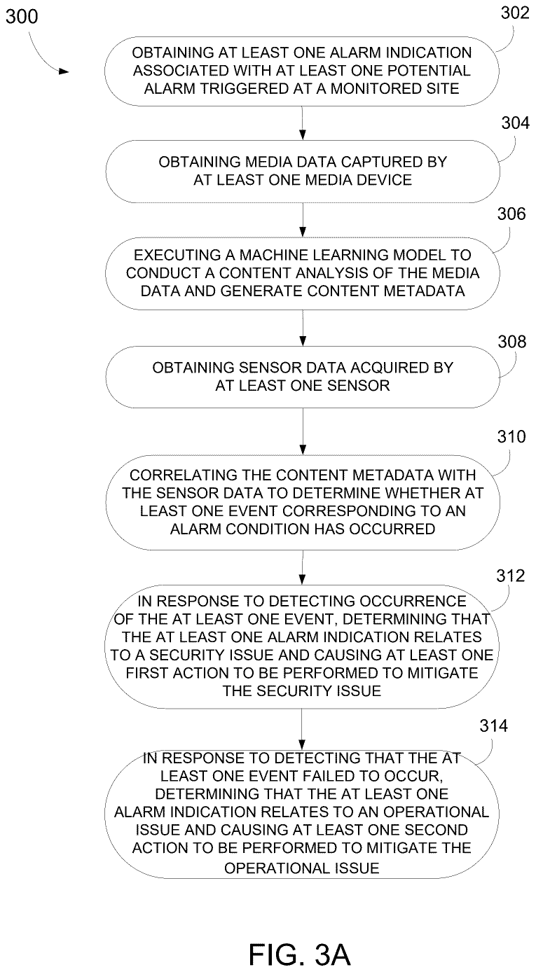

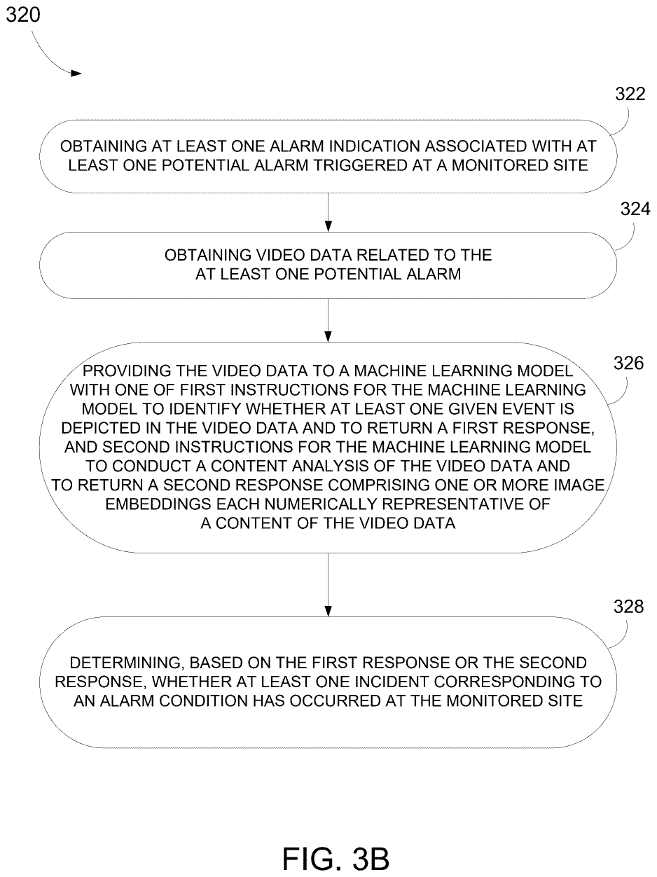

Referring now to FIG. 3A, a method 300 for alarm verification will now be described in accordance with one embodiment. The method 300 may be performed by the alarm verification engine 116 of FIG. 1. The method 300 comprises, at step 302, obtaining at least one alarm indication associated with at least one potential alarm triggered at a site monitored using a surveillance system, such as the system 100 of FIG. 1. The at least one alarm indication may be obtained from any component of the surveillance system and/or from a third-party system coupled to the surveillance system. In some embodiments, the at least one alarm indication is obtained from the surveillance system in real-time. In some embodiments, the at least one alarm indication is obtained from media device(s) and/or sensor(s) deployed at the monitored location. The method 300 further comprises, at step 304, obtaining media data captured by at least one of the media device(s) deployed at the monitored location. The media data may be obtained in any suitable manner including, but not limited to, directly from the media devices or retrieved from memory (e.g., from event occurrence records), as described herein above.

The method 300 further comprises, at step 306, executing a machine learning model to conduct a content analysis of the media data and generate content metadata based on the content analysis. The content analysis may be performed in any suitable manner, as described herein above. In some embodiments, the machine learning model is a multimodal model, optionally having image embedding capabilities.

The next step 308 comprises obtaining sensor data acquired by at least one of the sensor(s) deployed at the monitored location. The at least one sensor may be identified based on topographical information associated with the monitored location. The method 300 then comprises, at step 310, correlating the content metadata with the sensor data to determine whether at least one event corresponding to an alarm condition has occurred at the monitored location. This may be performed in the manner described herein above with reference to the correlation module 210 of FIG. 2. At step 312, the method 300 comprises, in response to detecting occurrence of the at least one event corresponding to the alarm condition, determining that the at least one alarm indication relates to a security issue and causing at least one first action to be performed to mitigate the security issue, in the manner described herein above (e.g., with reference to the mitigation module 212 of FIG. 2). In some embodiments, step 302 comprises performing a risk assessment and assigning a risk level to the alarm indication based on the assessment. At step 314, the method 300 comprises, in response to detecting that the at least one event corresponding to the alarm condition failed to occur, determining that the at least one alarm indication relates to an operational issue and causing at least one second action to be performed to mitigate the operational issue in the manner described herein above (e.g., with reference to the mitigation module 212).

Referring now to FIG. 3B, a method 320 for analyzing an alarm will now be described in accordance with another embodiment. The method 320 may be performed by the alarm verification engine 116 of FIG. 1. The method 320 comprises, at step 322, obtaining at least one alarm indication associated with at least one potential alarm triggered at a site monitored using a surveillance system, such as the system 100 of FIG. 1. The at least one alarm indication may be obtained in the manner described herein above. The method 320 further comprises, at step 324, obtaining video data related to the at least one potential alarm. Step 326 comprises providing the video data to a machine learning model with one of first instructions for the machine learning model to identify whether at least one given event is depicted in the video data and to return a first response, and second instructions for the machine learning model to conduct a content analysis of the video data and to return a second response comprising one or more image embeddings each numerically representative of a content of the video data. Step 328 then comprises determining, based on one of the first response and the second response from the machine learning model, whether at least one incident corresponding to an alarm condition has occurred at the monitored site.

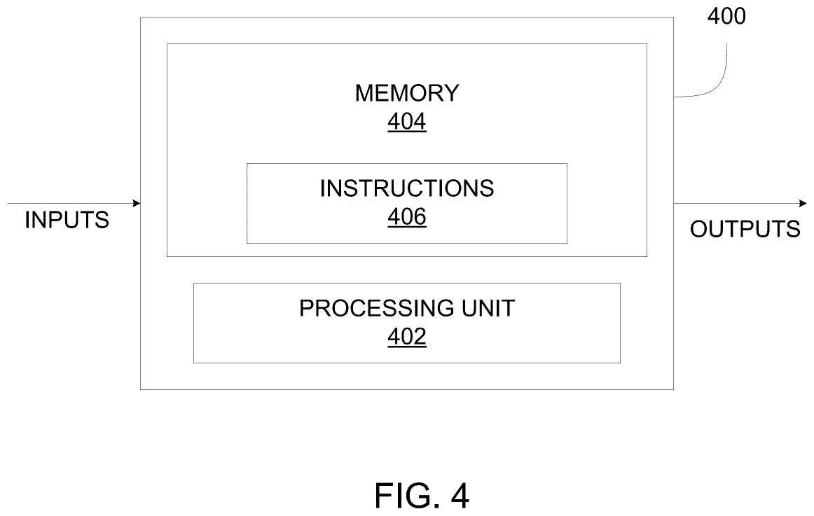

FIG. 4 is a schematic diagram of computing device 400, which may be used to implement one or more components of the system 100 of FIG. 1, such as the alarm verification engine 116, and/or to implement the method 300 of FIG. 3A and/or the method 320 of FIG. 3B. In certain embodiments, the computing device 400 is operable to register and authenticate users (using a login, unique identifier, and password for example) prior to providing access to applications, a local network, network resources, other networks, and network security devices. The computing device 400 may serve one user or multiple users.

The computing device 400 comprises a processing unit 402 and a memory 404 which has stored therein computer-executable instructions 406. The processing unit 402 may comprise any suitable devices configured to implement the functionality of the methods described herein such that instructions 406, when executed by the computing device 400 or other programmable apparatus, may cause the functions/acts/steps performed by methods as described herein to be executed. The processing unit 402 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitable programmed or programmable logic circuits, custom-designed analog and/or digital circuits, or any combination thereof. While in the example of FIG. 4, the processing unit 402 is shown as being unitary, the processing unit 402 may also be multicore, or distributed (e.g., a multi-processor).

The memory 404 may comprise any suitable known or other machine-readable storage medium. The memory 404 may comprise non-transitory computer readable storage medium, for example, but not limited to, an electronic, magnetic, optical, electromagnetic, infrared, or semiconductor system, apparatus, or device, or any suitable combination of the foregoing. The memory 404 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 404 may comprise any storage means (e.g. devices) suitable for retrievably storing machine-readable instructions 406 executable by the processing unit 402.

The memory 404, though shown as unitary for simplicity in the example of FIG. 4, may comprise multiple memory modules and/or caching. In particular, the memory 404 may comprise several layers of memory such as a hard drive, external drive (e.g. SD card storage) or the like and a faster and smaller RAM module. The RAM module may store data and/or program code currently being, recently being or soon to be processed by the processing unit 402 as well as cache data and/or program code from a hard drive. A hard drive may store program code and be accessed to retrieve such code for execution by the processing device 402 and may be accessed by the processing device 402 to store and access data. The memory 404 may have a recycling architecture for storing, for instance, data source and/or database coordinates, where older data files are deleted when the memory 404 is full or near being full, or after the older data files have been stored in memory 404 for a certain time.

The memory 404 stores program instructions and data used by the processing unit 402 to implement the alarm verification functions described herein. The memory 404 may also store locally media stream data, acting as a local database, as well as store information regarding the media devices (reference 110 in FIG. 1). For example, the memory 404 may store the identity, IP address, and configuration (e.g., type, transmission capability, reception capability, etc.) of the media devices 110.

In some embodiments, the systems and methods described herein may reduce false alarms by combining multiple sources of information to reach an assessment. The systems and methods described herein may assist operators in better understanding whether the alerts generated by the system 100 require a security response or a non-security response. The systems and methods described herein may further facilitate access to established or standard mitigation responses to different types of alerts. Indeed, operators might lack certainty regarding the appropriate response to certain types of alerts, and by using the systems and methods described herein to identify the appropriate mitigation and present this information to the user, it may be possible to reduce the risk of operators having to act without guidance. Furthermore, by using the systems and methods described herein to decide if the potential alarm relates to a security issue, an operational issue, or a false alarm, it may be possible to achieve a higher degree of automation of the processes involved, thus improving the efficiency of security operations.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references have been made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus, if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the examples described above and illustrated herein are intended to be examples only, and the appended claims are intended to include within their scope such processes, machines, manufacture, compositions of matter, means, methods, or steps.

What is claimed is:

1. A method for alarm verification in a surveillance system comprising one or more media devices and one or more sensors deployed at a monitored site, the method comprising:
at a computing device in communication with a machine learning model,
obtaining at least one alarm indication associated with at least one potential alarm triggered at the monitored site;
obtaining media data captured by at least one of the one or more media devices;
executing the machine learning model to conduct a content analysis of the media data and generate content metadata based on the content analysis;
obtaining sensor data acquired by at least one of the one or more sensors;
correlating the content metadata with the sensor data to determine whether at least one event corresponding to an alarm condition has occurred at the monitored site;
in response to detecting occurrence of the at least one event corresponding to the alarm condition, determining that the at least one alarm indication relates to a security issue and causing at least one first action to be performed to mitigate the security issue; and
in response to detecting that the at least one event corresponding to the alarm condition failed to occur, determining that the at least one alarm indication relates to an operational issue and causing at least one second action to be performed to mitigate the operational issue.

2. The method of claim 1, wherein the at least one alarm indication is obtained from the surveillance system in real-time.

3. The method of claim 2, wherein the at least one alarm indication is obtained from the one or more media devices and/or the one or more sensors.

4. The method of claim 1, wherein the at least one alarm indication is obtained from a third-party system coupled to the surveillance system.

5. The method of claim 1, wherein the at least one alarm indication is generated, at the computing device, based on at least one of the media data and the sensor data.

6. The method of claim 1, further comprising identifying the at least one of the one or more media devices based on a distance between a location of the at least one media device and a location at which the at least one potential alarm was triggered.

7. The method of claim 1, wherein a displacement of at least one object along a direction movement caused the at least one potential alarm to be triggered, further comprising identifying the at least one of the one or more media devices based on a position of the at least one media device relative to the direction of movement.

8. The method of claim 1, further comprising identifying the at least one of the one or more sensors based on topological data associated with the monitored site, the topological data indicative of a layout of areas of the monitored site and of an arrangement of the one or more sensors within the areas.

9. The method of claim 1, wherein obtaining the media data comprises retrieving the media data from a plurality of event occurrence records stored in at least one database and/or obtaining the sensor data comprises retrieving the sensor data from the plurality of event occurrence records.

10. The method of claim 1, wherein obtaining the media data comprises receiving the media data from the at least one of the one or more media devices and/or obtaining the sensor data comprises receiving the sensor data from the at least one of the one or more sensors.

11. The method of claim 1, wherein obtaining the media data comprises obtaining at least one of image data and video data.

12. The method of claim 1, wherein the content metadata is indicative of at least one of a detected presence of one or more individuals and/or objects at the monitored site, a number of the one or more individuals and/or objects, a detected motion of the one or more individuals and/or objects, and at least one of a speed of motion and a direction of motion of the one or more individuals and/or objects.

13. The method of claim 1, wherein the sensor data is acquired by the at least one of the one or more sensors comprising at least one motion sensor, at least one glass breakage sensor, at least one door contact sensor, at least one window contact sensor, at least one request to exit sensor, at least one fire sensor, at least one smoke sensor, at least one sound sensor, at least one infrared sensor, at least one pressure sensor, at least one tension sensor, at least one magnetic sensor, at least one temperature sensor, at least one humidity sensor, and/or at least one access control device.

14. The method of claim 1, wherein the at least one event comprises a door forced open event, a door held open event, an access denied event, a break event, a fire, a gunshot event, a person detected event, a vehicle detected event, an object detected event, and/or actuation of a panic button.

15. The method of claim 1, wherein the at least one alarm indication comprises alarm metadata, further comprising correlating the content metadata and the sensor data with the alarm metadata to determine whether the at least one event has occurred.

16. The method of claim 15, wherein the alarm metadata comprises at least one of a name of the at least one potential alarm, an instance identifier for the at least one potential alarm, a description of the at least one potential alarm, a timestamp associated with the at least one potential alarm, and an identification of a device having triggered the at least one potential alarm.

17. The method of claim 15, wherein the sensor data comprises first sensor data and second sensor data, further wherein the alarm metadata is correlated with the first sensor data and the content metadata is correlated with the second sensor data to determine whether the at least one event has occurred.

18. The method of claim 1, wherein the sensor data comprises first sensor data and second sensor data, and the content metadata comprises first content metadata and second content metadata, further comprising at least one of correlating the first sensor data with the second sensor data and correlating the first content metadata with the second content metadata to determine whether the at least one event has occurred.

19. The method of claim 1, wherein causing the at least one first action to be performed to mitigate the security issue comprises conducting, based on a correlation of sensor data from multiple sensors, a risk assessment to assign a risk level to the at least one alarm indication.

20. The method of claim 19, wherein causing the at least one first action to be performed to mitigate the security issue comprises assigning, based on the risk assessment, a low risk level to the security issue, and outputting instructions to cause security personnel to be dispatched at the monitored site.

21. The method of claim 19, wherein causing the at least one first action to be performed to mitigate the security issue comprises assigning, based on the risk assessment, a high risk level to the security issue, and outputting instructions to cause escalation of the security issue to an emergency service.

22. The method of claim 1, wherein causing the at least one second action to be performed to mitigate the operational issue comprises outputting instructions to cause maintenance to be performed on the one or more media devices and/or the one or more sensors.

23. A system for analyzing an alarm, the system comprising:
a processing unit; and
a non-transitory computer-readable medium having stored thereon program instructions executable by the processing unit for:
obtaining at least one alarm indication associated with at least one potential alarm triggered at a monitored site;
obtaining video data related to the at least one potential alarm;
providing the video data to a machine learning model with one of first instructions for the machine learning model to identify whether at least one given event is depicted in the video data and to return a first response, and second instructions for the machine learning model to conduct a content analysis of the video data and to return a second response comprising one or more image embeddings each numerically representative of a content of the video data; and
determining, based on one of the first response and the second response from the machine learning model, whether at least one incident corresponding to an alarm condition has occurred at the monitored site.
